(19) United States
(12) Patent Application Publication
(10) Pub. No.: US 2025/0065476 A1
(43) Pub. Date: Feb. 27, 2025

(54) Discontinuous screwdriving device with damping means

(71) Applicant: ETABLISSEMENTS GEORGES RENAULT, SAINT HERBLAIN (FR)

(72) Inventors: Pierre Guilbaud, NANTES (FR); Olivier Mege, SAINT HERBLAIN (FR); Yvon Lesueur, NANTES (FR)

(21) Appl. No.: 18/722,047

(22) PCT Filed: Dec. 14, 2022
(86) PCT No.: PCT/EP2022/085768

§ 371 Date: Jun. 20, 2024

(30) Foreign Application Priority Data
Dec. 21, 2021 (FR) 2114181

(51) Int. Cl. B25B 21/02; B25F 5/00

(52) U.S. Cl. CPC B25B 21/026; B25F 5/006

(57) ABSTRACT

A discontinuous screwdriving device includes: a motor provided with a rotor; an inertial element able to be driven in rotation by the rotor to store kinetic energy during successive acceleration phases; and an output shaft able to drive an element to be screwed in rotation. The output shaft includes at least one first striking surface. The inertial element includes: at least one drive element linked to the rotor and inapt to come into contact with the at least one first striking surface of the output shaft; and at least one striking element including at least one second striking surface intended to come into contact with the at least one first striking surface of the output shaft during successive impact phases. The at least one driving element and the at least one striking element are linked together by at least one damping element.

### 1. CROSS-REFERENCE TO RELATED APPLICATIONS

This application is a Section 371 National Stage Application of International Application No. PCT/EP2022/085768, filed Dec. 14, 2022, and published as WO 2023/117609 A1 on Jun. 29, 2023, not in English, which claims priority to French Patent Application No. 2114181, filed Dec. 21, 2021, the contents of which are hereby incorporated by reference in their entireties.

### 2. FIELD OF THE DISCLOSURE

The field of the disclosure is that of the design and manufacture of impact screwdriving devices.

More particularly, the disclosure invention relates to impact damping and attenuation of the noise generated by such devices.

### 3. PRIOR ART

Impact screwdriving devices, also so-called impact wrenches or pulse screwdriving tools, are commonly used in various sectors to proceed with screwing and/or unscrewing assemblies.

An impact wrench or a pulse screwdriving tool conventionally comprises an output shaft and a motor provided with a rotor capable of driving in rotation, continuously or intermittently, a striking mechanism capable of accumulating kinetic energy during acceleration phases and then transferring it to the output shaft, during successive impact phases, to transmit a torque to the output shaft. Thus, the output shaft, which drives a drive element able to cooperate with an element to be screwed, transmits, at each impact, a torque to an element to be screwed in order to ensure tightening thereof.

Impact wrenches and pulse screwdriving tools allow efficiently carrying out tightening at high torque levels while inducing in the hand of the operator holding the tool just a low-magnitude reaction.

Nonetheless, impact wrenches and the pulse screwdriving tools have the drawback of generating the emission of noises which, in some cases, could induce noise pollution.

The noises generated at each impact in the striking mechanism may reverberate by following several transmission paths, namely:
an aerial path inducing that the acoustic energy is transmitted directly into the air;
a solid path inducing that the acoustic energy is progressively transmitted through the solids in contact before being finally radiated and transmitted into the air.

In order to limit the propagation of noise, various technical solutions have been considered.

One technique, described in the document DE-A1-102004032789, consists in placing damping elements between the casing of the impact wrench and the impact mechanism so as to limit the transmission of noise to the casing.

Another technique, described in the documents US-A1-2006225909 and JP-A-200807379, consists in implementing an output shaft comprising two portions joined by a damping element in order to limit the transmission of the resonance of the components of the impact wrench to the assembly.

These solutions allow reducing the propagation of the noises generated when carrying out a screwing/unscrewing operation by means of an impact wrench.

Nonetheless, they do not allow attenuating the noises generated by the striking mechanism transmitted by the parts placed upstream of the damping points being implemented.

Consequently, it is possible to further reduce the propagation of these noises.

### 4. SUMMARY

An aspect of the present disclosure provides a discontinuous screwdriving device comprising:
a motor provided with a rotor;
an inertial element able to be driven in rotation by said rotor to store kinetic energy during successive acceleration phases;
an output shaft able to drive an element to be screwed in rotation, said output shaft comprising at least one first striking surface;
said inertial element comprising:
at least one drive element linked to said rotor and inapt to come into contact with said at least one first striking surface of said output shaft;
at least one striking element comprising at least one second striking surface intended to come into contact with said at least one first striking surface of said output shaft during successive impact phases.

According to an aspect of the present disclosure, said at least one driving element and said at least one striking element are linked together by means of at least one damping element.

Thus, according to this aspect of the disclosure, a damping element is interposed between the striking element and the structure linking it to the rotor, i.e. at the parts generating the noises when hitting each other.

In this manner, an aspect of the present disclosure contributes to limiting the generation of noises at their source and to reducing the aerial transmission of noise by the different components of the impact wrench.

According to a possible variant, said inertial element comprises:
a cage linked in rotation to said rotor;
at least one movable member, comprising said striking element provided with said at least one second striking surface, said movable member comprising a portion for connection to said cage secured to said striking element by said damping element, said movable member being movable relative to said cage between at least:
an engagement position in which said at least one second striking surface could come into contact with said at least one first striking surface to transmit a torque to said output shaft;
a disengagement position in which said at least one second striking surface cannot come into contact with said at least one first striking surface to enable said inertial element to accelerate freely.

According to a possible variant, said movable member is movable in rotation between its engagement and disengagement positions along an axis parallel to the axis of rotation of said motor.

According to a possible variant, said movable member is movable in translation between its engagement and disengagement positions along an axis parallel to the axis of rotation of said motor.

According to a possible variant, said at least one movable member comprises two lateral plates and a central plate secured to said lateral plates by said damping elements, said at least one movable member being rotatably linked to said cage by means of needles parallel to the axis of rotation of said motor, said central plate comprising rooms enabling passage of said needles without contact from one lateral plate to another.

According to a possible variant, said damping element comprises two sheets of damping material arranged between said central plate and each of said lateral plates.

According to a possible variant, said at least one movable element comprises an axis comprising said portion for connection to said cage and a striking portion comprising said at least one second striking surface linked together by said damping element, said striking portion being not in contact with said cage in any of the positions of said movable member.

According to a possible variant, said at least one movable element comprises an axis, said cage comprising a portion for securing to said rotor and a portion for driving said axis, the two portions of said cage being secured together by means of said damping element.

According to a possible variant, said inertial element comprises:
a bell rotatably linked to said rotor;
a ring comprising said striking element provided with said at least one second striking surface,
said ring and said bell being linked together by means of said damping element.

According to a possible variant, said inertial element is able to rotate in the direction of unscrewing upon completion of each of said impact phases.

According to a possible variant, said damping element is made of an elastomeric material.

According to a possible variant, said elastomeric material belongs to the group comprising:
natural rubbers;
synthetic rubbers;
neoprene;
nitrile.

### 5. DESCRIPTION OF THE FIGURES

Other features and advantages of the disclosure will become apparent upon reading the following description of particular embodiments, given as a simple illustrative and non-limiting example, and from the appended drawings, wherein:

FIG. 1 illustrates a longitudinal sectional view of a screwing/unscrewing device according to a first embodiment comprising a twin-hammer type striking mechanism;

FIG. 2 illustrates an exploded view of the striking mechanism of the device of FIG. 1;

FIG. 3 illustrates a sectional view according to the axis A-A of the device of FIG. 1 the hammers of which are in the release position;

FIG. 4 illustrates a sectional view according to the axis A-A of the device of FIG. 1 the hammers of which are in the engagement position;

FIG. 5 illustrates a perspective view of a hammer of the mechanism of FIG. 2;

FIG. 6 illustrates an exploded view of the hammer of FIG. 5;

FIG. 7 illustrates a sectional view of the striking mechanism of FIG. 2 according to a plane passing through the central plate of a hammer;

FIG. 8 illustrates an exploded view of the dog-clutch type striking mechanism implemented in a second embodiment;

FIG. 9 illustrates a cross-sectional view of the striking mechanism of FIG. 8;

FIG. 10 illustrates an exploded view of the pin-type striking mechanism implemented in a third embodiment.

### 6. DESCRIPTION OF PARTICULAR EMBODIMENTS

### 6.1. First Embodiment: Twin Hammer

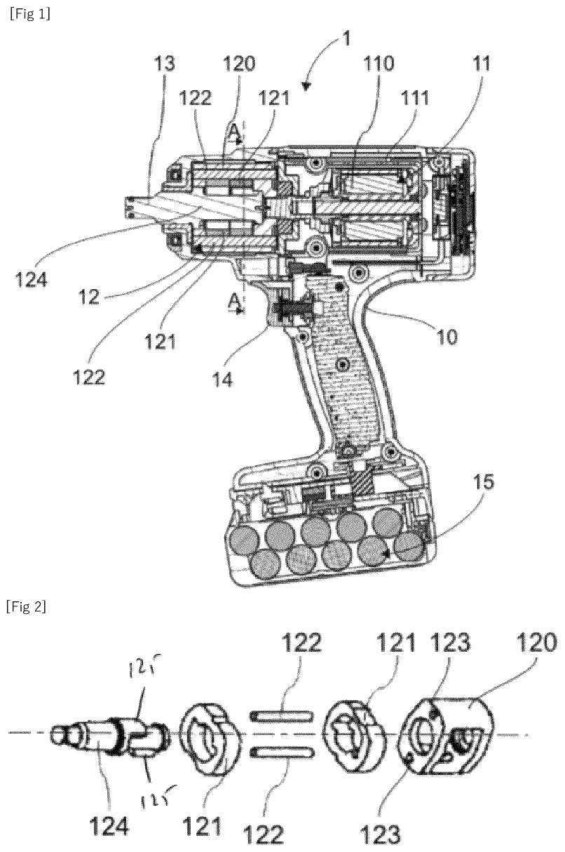

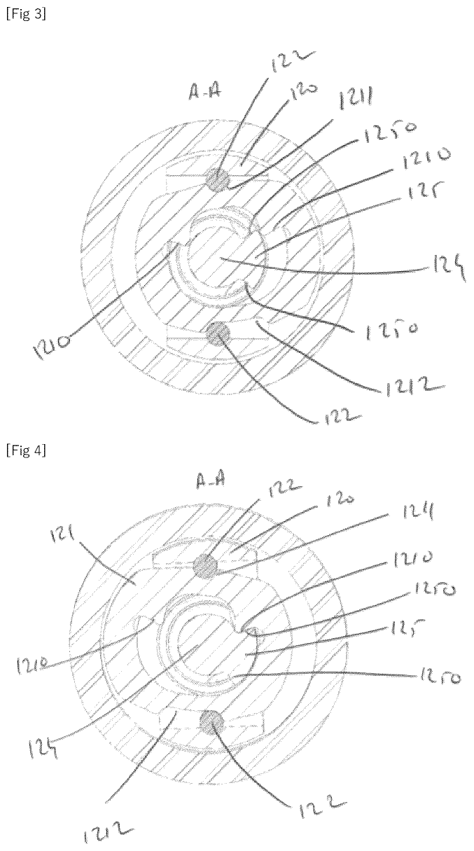

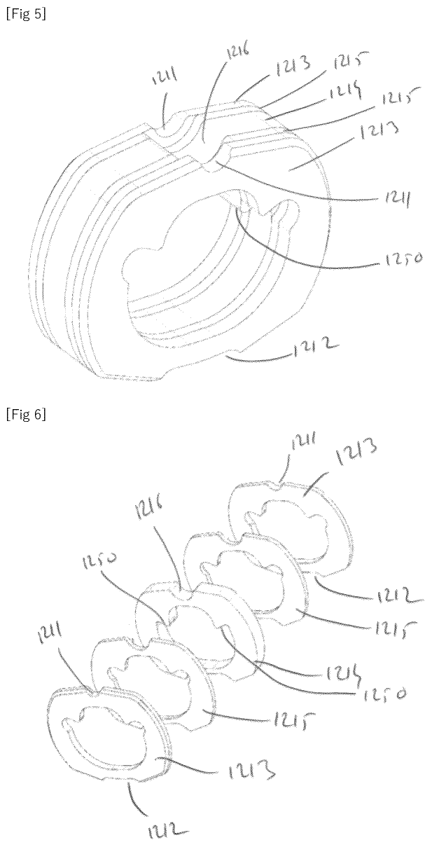

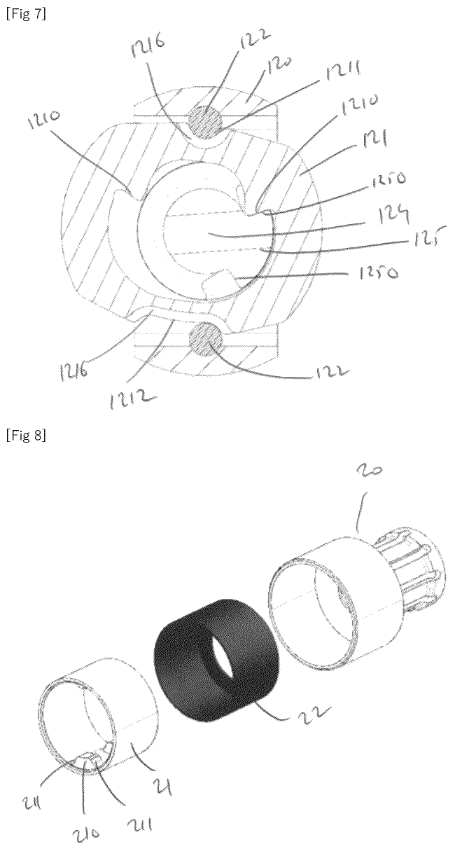

Referring to FIGS. 1 to 7, a first example of an impact wrench according to an aspect of the present disclosure implementing a “twin-hammer” type impact mechanism is described.

Such an impact wrench 1 comprises a casing 10 accommodating an electric motor 11, an impact mechanism 12 and a rotary output member, or square, 13 intended to cooperate with a screwing/unscrewing bushing. The impact wrench comprises an actuation trigger 14.

The motor 11 comprises a rotor 111 and a stator 110. It consists of an electric motor. Preferably, the motor will be of the permanent magnet synchronous type. Alternatively, it may consist of any other type of electric motor like, for example, a DC motor, an asynchronous motor, a variable-reluctance motor, a stepper motor, etc. It could be single- or multi-phase. It could possibly consist of a pneumatic motor.

The rotor 111 may be connected, or not, directly to the input of the impact mechanism 12. If so, the transmission ratio between the rotor and the input of the impact mechanism 12 is equal to 1.

The impact mechanism 12 is of the “twin-hammer” type.

The impact mechanism 12 comprises a cage 120 movable in rotation herein in direct engagement with the rotor 111 to which it is connected in rotation. Hence, the connection is rigid between the rotor and the cage. When the engagement is not direct, a gear transmission may be interposed between the rotor and the cage.

The cage 120 is hollowed and accommodates two hammers 121 secured thereto movable in rotation about axes substantially parallel to the axis of rotation of the bell; i.e. of the motor, by means of needles 122 fitted into notches 123 formed to this end in the bell 120.

The impact mechanism 12 comprises an output shaft 124, extending partially inside the hammers 121 and the bell 120. The output shaft 124 is connected in rotation with the rotary output member 13. The output shaft comprises one or more anvil(s) 125 each herein defining two striking surfaces 1250 formed on two opposite sides. This allows ensuring screwing as well as unscrewing. One single striking surface could be implemented to allow ensuring only one screwing or unscrewing operation type.

The hammers 121 also comprise two striking surfaces 1210 which are intended to hit the corresponding striking surfaces 1250 of the output square. Like for the output square, the hammers could comprise only one striking surface.

Each hammer comprises passages 1211 and 1212 enabling passage of the needles 122. The notch 1212 stretches to form a slide so that each hammer is movable relative to the bell between two positions, namely:
a disengagement position in which the cage and the hammers can rotate about the output square without the striking surfaces of the hammers hitting the striking surfaces of the output square;
an engagement position in which the striking surfaces of the hammers could hit the striking surfaces of the output square.

Conventionally,
the cage is driven in rotation by the motor and stores kinetic energy while the hammers occupy their release position;
because of the shape of the hammers and of the output shaft, the hammers are placed in their engagement position;
when the cage and the hammers reach an impact angular position, because of their placement in the engagement position, the striking surfaces of the hammers come into contact with the striking surfaces of the output square and create a torque impact on the latter such that a torque is transmitted to the output shaft which is driven in rotation;
because of their shape, the hammers then take on the disengagement position and the cage can then rotate without generating any impact in order to store kinetic energy again.

Several cycles follow one another in this way until the assembly is properly tightened or loosened.

In general, an impact mechanism comprises:
an inertial element or flywheel (herein the cage 120);
anvils 125 (linked to the output square 124);
a mechanical connection device between the flywheel and the anvil (herein the hammers 121 which form movable elements comprising striking elements).

Each hammer 121 herein comprises two lateral plates 1213 between which a central plate 1214 is located. The lateral plates 1213 are secured to the central plate 1214 by means of a damping element 1215. This damping element 1215 is herein in the form of a sheet. It is made of an elastomer and preferably belongs to the group comprising
natural rubbers;
synthetic rubbers;
neoprene;
nitrile.

The central plate 1214 of each hammer 121 comprises a room 1216 enabling passage of the needles 122 without contact from one lateral plate 1213 to another.

Thus, the lateral plates 1213 form a portion for connection to the cage secured, by means of the damping elements 1215, to the striking portion formed by the central plate 1214.

Therefore, the central plate 12147 is not in direct contact with the needles 122. Only the lateral plates 1213 are so.

Conversely, only the central plate 1214 is in contact with the output shaft during the impacts, the lateral plates 1213 having no surface in contact.

Thus, the transmission of the impact to the needles and to the cage is done via the damping elements, which considerably limits the transmission of the acoustic energy. In this way, the generated noises are reduced at their source.

### 6.2. Second Embodiment: Dog Clutch

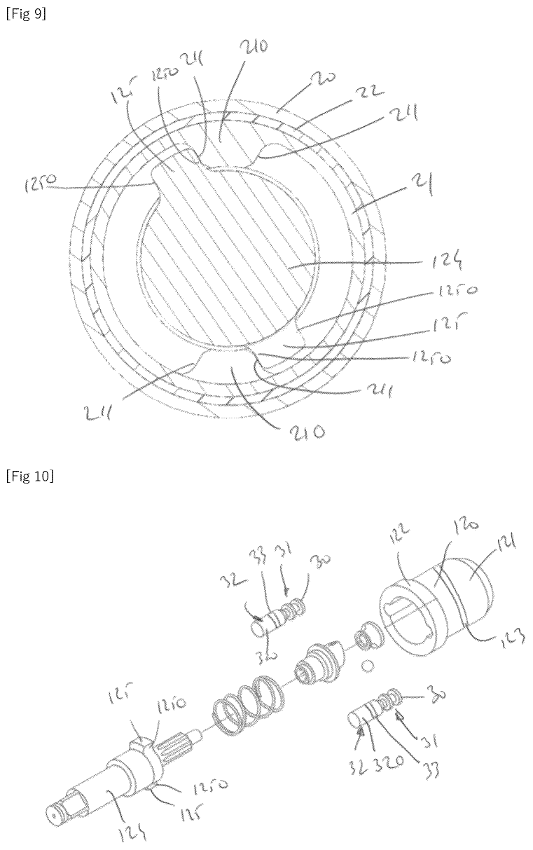

Referring to FIGS. 8 and 9, a second example of an impact wrench according to an aspect of the present disclosure implementing a dog-clutch type impact mechanism.

Only the main differences between the first and second embodiments are described hereinafter.

In this embodiment, the impact mechanism comprises a bell 20 forming the inertial element connected to the motor and a ring 21 comprising the striking element provided with radial protruding portions 210 having striking surfaces 211 able to be hit against the striking surfaces 1250 of the output shaft 124.

The ring 21 and the bell 20 are linked together by means of a damping element 22. The latter is herein in the form of a cylindrical ring made of an elastomer.

Conventionally, the operation of the dog-clutch type striking mechanism is as follows:
the bell is driven in rotation by the motor and stores kinetic energy during a free acceleration phase during which the striking surfaces of the ring are not in contact with the striking surfaces of the output shaft;
when the bell reaches a given angular position with respect to the output shaft, the drive of the motor stops the supply of the motor with power and then the striking surfaces of the ring come into contact with that of the output shaft which creates a torque impact on the latter so that a torque is transmitted to the output shaft which is driven in rotation;
the bell and the rotor of the motor “bounce”, i.e. since the motor is no longer powered, they rotate backwards until reaching a rear position;
the motor is then powered again and drives the bell again.

Several cycles follow one another in this way until the assembly is properly tightened or loosened.

To the extent that the bell 20 connected to the motor and the ring 21, which comprises the striking surfaces colliding with the output shaft, are separated by the damping element 21, the acoustic energy is absorbed the closest to the impacts, which limits transmission thereof to the parts further downstream and thus limits the propagation of noise.

### 6.3. Third Embodiment: Pin Clutch

Referring to FIG. 10, a second example of an impact wrench according to an aspect of the present disclosure implementing a “pin-clutch” type impact mechanism is described.

Only the main differences between the first and second embodiments are described hereinafter.

The members movable relative to the cage and including the striking surfaces herein comprise axes 30 that are movable in translation along the axis of the motor relative to the cage between:
a release position in which they cannot collide with the striking surfaces 1250 of the output shaft 124, and
an engagement position in which they could come into contact with the striking surfaces 1250 of the output shaft 124.

Each axis 30 comprises a portion 31 for connection to the cage 120 and a striking portion 32 comprising at least one striking surface 320. These two portions are linked together by a damping element 33, the striking portion not being in contact with the cage in any of the positions of the axis.

Alternatively or complementarily, the axes are made in one-piece but the cage comprises a portion 121 for securing to the rotor and a portion 122 for driving the axes, at which the axes are movably linked between their two positions. The two portions of the cage are secured together by the damping element 123.

### 6.4. Other Variants

The principle according to an aspect of the present disclosure, which includes interposing a damping element between the portion of the impact mechanism driven by the motor and that which hits against the output shaft, may be implemented in other types of impact mechanisms such as, in particular, rocking dogs, 2-jaws, spring loaded cam, etc.

### 6.5 Conclusion

An exemplary aspect of the present disclosure provides an effective solution to at least some of these different problems.

In particular, an exemplary aspect provides a pulse screwdriving tool wherein the transmission of the noises generated by the impact mechanism is attenuated.

In particular, an exemplary aspect provides such a pulse screwdriving tool which contributes to attenuating the transmission of the noises generated in the striking mechanism the closest to the source of emission of these noises.

Another an exemplary aspect provides such a pulse screwdriving tool allowing preventing the aerial transmission of noises from their emission source, i.e. from the parts of the impact mechanism hitting each other.

Another an exemplary aspect provides, in at least one embodiment, such a pulse screwdriving tool which is simple and/or compact and/or robust and/or effective.

Although the present disclosure has been described with reference to one or more examples, workers skilled in the art will recognize that changes may be made in form and detail without departing from the scope of the disclosure and/or the appended claims.

1. A discontinuous screwdriving device comprising:
a motor provided with a rotor;
an inertial element able to be driven in rotation by said rotor to store kinetic energy during successive acceleration phases;
an output shaft able to drive an element to be screwed in rotation, said output shaft comprising at least one first striking surface;
said inertial element comprising:
at least one drive element linked to said rotor and inapt to come into contact with said at least one first striking surface of said output shaft;
at least one striking element comprising at least one second striking surface adapted to come into contact with said at least one first striking surface of said output shaft during successive impact phases,
wherein said at least one driving element and said at least one striking element are linked together by at least one damping element.

2. The discontinuous screwdriving device according to claim 1, wherein said inertial element comprises:
a cage linked in rotation to said rotor;
at least one movable member, comprising said striking element provided with said at least one second striking surface, said movable member comprising a portion for connection to said cage secured to said striking element by said damping element, said movable member being movable relative to said cage between at least:
an engagement position in which said at least one second striking surface could come into contact with said at least one first striking surface to transmit a torque to said output shaft;
a disengagement position in which said at least one second striking surface cannot come into contact with said at least one first striking surface to enable said inertial element to accelerate freely.

3. The discontinuous screwdriving device according to claim 2, wherein said movable member is movable in rotation between its engagement and disengagement positions along an axis parallel to the axis of rotation of said motor.

4. The discontinuous screwdriving device according to claim 2, wherein said movable member is movable in translation between its engagement and disengagement positions along an axis parallel to the axis of rotation of said motor.

5. The discontinuous screwdriving device according to claim 3, wherein said at least one movable member comprises first and second lateral plates and a central plate secured to said first and second lateral plates by said damping elements, said at least one movable member being rotatably linked to said cage by using needles parallel to the axis of rotation of said motor, said central plate comprising rooms enabling passage of said needles without contact from one of the first and second lateral plates to another of the first and second lateral plates.

6. The discontinuous screwdriving device according to claim 5, wherein said damping element comprises first and second sheets of damping material arranged between said central plate and each of said first and second lateral plates.

7. The discontinuous screwdriving device according to claim 4, wherein said at least one movable element comprises an axis comprising said portion for connection to said cage and a striking portion comprising said at least one second striking surface linked together by said damping element, said striking portion being not in contact with said cage in any of the positions of said movable member.

8. The discontinuous screwdriving device according to claim 2, wherein said movable member is movable in at least one of rotation or translation between its engagement and disengagement positions along an axis parallel to the axis of rotation of said motor, and wherein said at least one movable element comprises an axis, said cage comprising a portion for securing to said rotor and a portion for driving said axis, the two portions of said cage being secured together by means of said damping element.

9. The discontinuous screwdriving device according to claim 1, wherein said inertial element comprises:
a bell rotatably linked to said rotor;
a ring comprising said striking element provided with said at least one second striking surface,
said ring and said bell being linked together by said damping element.

10. The discontinuous screwdriving device according to claim 9, wherein said inertial element is able to rotate in the direction of unscrewing upon completion of each of said impact phases.

11. The discontinuous screwdriving device according to claim 1, wherein said damping element is made of an elastomeric material.

12. The discontinuous screwdriving device according to claim 11, wherein said elastomeric material belongs to the group consisting of:
natural rubbers;
synthetic rubbers;
neoprene;
nitrile.
